(19) United States
(12) Patent Application Publication
(10) Pub. No.: US 2019/0380109 A1
(43) Pub. Date: Dec. 12, 2019

(54) RADIO ACCESS NETWORK PAGING PROCEDURE BASED ON NETWORK SLICE

(71) Applicant: Nokia Solutions and Networks Oy, Espoo (FI)

(72) Inventors: Sumesh PARAMESWARAN NAIR, Aluva (IN); Rajesh Babu NATARAJAN, Bangalore (IN)

(21) Appl. No.: 16/423,705

(22) Filed: May 28, 2019

(30) Foreign Application Priority Data
Jun. 11, 2018 (IN) 201841021784

(51) Int. Cl. H04W 68/02

(52) U.S. Cl. CPC H04W 68/02; H04W 68/12

(57) ABSTRACT

Various communication systems may benefit from improved radio access network paging procedures. For example, it may be helpful to enhance radio access network paging procedures for a user equipment in a radio resource control inactive mode. According to certain embodiments a method may include receiving a setup request at a network entity. The setup request may comprise a supported radio access network based notification area for a user equipment movement in a radio resource control inactive mode. The method may also include transmitting a radio access network paging message from the network entity to a neighboring network entity supporting a configured network slice within the supported radio access network based notification area. The method may further include paging for the user equipment in a radio resource control inactive mode in cells included in the radio access network based notification area that support the configured network slice for the user equipment.

### BACKGROUND

### Field

Various communication systems may benefit from improved radio access network paging procedures. For example, it may be helpful to enhance radio access network paging procedures when a user equipment is in a radio resource control inactive mode.

### Description of the Related Art

In third generation partnership project (3GPP) technology, such as Fifth Generation (5G), New Radio (NR), Next Generation (NG) technology, a user equipment (UE) may be in a radio resource control (RRC) connected, RRC inactive, or idle mode. In an RRC Inactive State, the user equipment may, for example, remain in a connection management connected mode (CM) and broadcast system information. Paging for a UE in an RRC Inactive State and CM connected state is managed by the radio access network (RAN). The UE in the RRC inactive mode may also move within an area configured by an NG RAN node without notifying the RAN of the movement. The area within which the UE moves may be referred to as a RAN-Based notification area (RNA).

When the UE is in an RRC inactive mode, the last serving RAN node may keep or store the UE context and/or the UE associated NG connection with a serving access and mobility management function (AMF) or the user plane function (UPF). When the last serving RAN node receives downlink data from the UPF or a downlink signaling from the AMF, while the user equipment is in an RRC inactive mode, the RAN node sends an access point RAN paging to one or more neighboring RAN nodes included in the RNA. RNA configuration assumes a uniform profile for UEs across the whole network irrespective of the network slice that is serving the UE.

### SUMMARY

According to certain embodiments, an apparatus may include at least one memory including computer program code, and at least one processor. The at least one memory and the computer program code may be configured, with the at least one processor, to cause the apparatus at least to receive a setup request. The setup request may comprise a supported radio access network based notification area for a user equipment movement in a radio resource control inactive mode. The at least one memory and the computer program code may also be configured, with the at least one processor, to cause the apparatus at least to transmit a radio access network paging message to a neighboring network entity supporting a configured network slice within the supported radio access network based notification area.

According to certain embodiments, a method may include receiving a setup request at a network entity. The setup request may comprise a supported radio access network based notification area for a user equipment movement in a radio resource control inactive mode. The method may also include transmitting a radio access network paging message from the network entity to a neighboring network entity supporting a configured network slice within the supported radio access network based notification area.

An apparatus, in certain embodiments, may include means for receiving a setup request. The setup request may comprise a supported radio access network based notification area for a user equipment movement in a radio resource control inactive mode. The apparatus may also include means for transmitting a radio access network paging message to a neighboring network entity supporting a configured network slice within the supported radio access network based notification area.

According to certain embodiments, a non-transitory computer-readable medium encoding instructions that, when executed in hardware, perform a process. The process may include receiving a setup request at a network entity. The setup request may comprise a supported radio access network based notification area for a user equipment movement in a radio resource control inactive mode. The process may also include transmitting a radio access network paging message from the network entity to a neighboring network entity supporting a configured network slice within the supported radio access network based notification area.

According to certain other embodiments, a computer program product may encode instructions for performing a process. The process may include receiving a setup request at a network entity. The setup request may comprise a supported radio access network based notification area for a user equipment movement in a radio resource control inactive mode. The process may also include transmitting a radio access network paging message from the network entity to a neighboring network entity supporting a configured network slice within the supported radio access network based notification area.

An apparatus, according to certain embodiments, may include circuitry for receiving a setup request. The setup request may comprise a supported radio access network based notification area for a user equipment movement in a radio resource control inactive mode. The apparatus may also include circuitry for transmitting a radio access network paging message to a neighboring network entity supporting a configured network slice within the supported radio access network based notification area.

According to certain embodiments, an apparatus may include at least one memory including computer program code, and at least one processor. The at least one memory and the computer program code may be configured, with the at least one processor, to cause the apparatus at least to receive a radio access network paging message from a network entity. The apparatus may be located within a supported radio access network based notification area for a user equipment movement in a radio resource control inactive mode. The at least one memory and the computer program code may also be configured, with the at least one processor, to cause the apparatus at least to page the user equipment in the radio resource control inactive mode after receiving the radio access network paging message from the network entity. The paging of the user equipment may occur in a configured network slice within the supported radio access network based notification area.

According to certain embodiments, a method may include receiving a radio access network paging message at a neighboring network entity from a network entity. The neighboring network entity may be located within a supported radio access network based notification area for a user equipment movement in a radio resource control inactive mode. The method may also include paging the user equipment in the radio resource control inactive mode after receiving the radio access network paging message from the network entity. The paging of the user equipment may occur in a configured network slice within the supported radio access network based notification area.

An apparatus, in certain embodiments, may include means for receiving a radio access network paging message from a network entity. The apparatus may be located within a supported radio access network based notification area for a user equipment movement in a radio resource control inactive mode. The apparatus may also include means for paging the user equipment in the radio resource control inactive mode after receiving the radio access network paging message from the network entity. The paging of the user equipment may occur in a configured network slice within the supported radio access network based notification area.

According to certain embodiments, a non-transitory computer-readable medium encoding instructions that, when executed in hardware, perform a process. The process may include receiving a radio access network paging message at a neighboring network entity from a network entity. The neighboring network entity may be located within a supported radio access network based notification area for a user equipment movement in a radio resource control inactive mode. The process may also include paging the user equipment in the radio resource control inactive mode after receiving the radio access network paging message from the network entity. The paging of the user equipment may occur in a configured network slice within the supported radio access network based notification area.

According to certain other embodiments, a computer program product may encode instructions for performing a process. The process may include receiving a radio access network paging message at a neighboring network entity from a network entity. The neighboring network entity may be located within a supported radio access network based notification area for a user equipment movement in a radio resource control inactive mode. The process may also include paging the user equipment in the radio resource control inactive mode after receiving the radio access network paging message from the network entity. The paging of the user equipment may occur in a configured network slice within the supported radio access network based notification area.

An apparatus, according to certain embodiments, may include circuitry for receiving a radio access network paging message from a network entity. The apparatus may be located within a supported radio access network based notification area for a user equipment movement in a radio resource control inactive mode. The apparatus may also include paging the user equipment in the radio resource control inactive mode after receiving the radio access network paging message from the network entity. The paging of the user equipment may occur in a configured network slice within the supported radio access network based notification area.

### BRIEF DESCRIPTION OF THE DRAWINGS:

For proper understanding of the example embodiments of the invention, reference should be made to the accompanying drawings, wherein:

FIG. 1 illustrates an example of a system according to certain embodiments.

FIG. 2 illustrates an example of a signal flow diagram according to certain embodiments.

FIG. 3 illustrates an example of a signal flow diagram according to certain embodiments.

FIG. 4 illustrates an example of a signal flow diagram according to certain embodiments.

FIG. 5 illustrates an example of a flow diagram according to certain embodiments.

FIG. 6 illustrates an example of a flow diagram according to certain embodiments.

FIG. 7 illustrates an example of a system according to certain embodiments.

### DETAILED DESCRIPTION

Certain embodiments may allow a RAN node, such as a 5G or NR NodeB (gNB) or an NG enhanced NodeB (ng eNB), to inform a neighboring network entity of the configuration of one or more RNAs inside the sending or network entity. The RNA information may be transmitted, for example, through the Xn interface. In some embodiments, the configured RNA information may be transmitted as part of an Xn setup procedure. Updates or modifications of the RNA configuration may also be signaled or transmitted to the neighboring network entity using Xn. The updates or modifications may be referred to as a NG-RAN Node Configuration Update Procedure.

Based on current 3GPP standards, RAN paging is done irrespective of the network slice configuration, which may lead to unnecessary paging for a UE in an inactive mode for cells that do not belong to the concerned network slice. The UE in an inactive mode, for example, may be referred to as an RRC_INACTIVE UE. Certain embodiments may help to inform network entities located within the network of the supported network slices for a UE during RAN paging. For example, the supported network slice identification of a UE may be transmitted to a neighboring network entity. The supported network slice identification, in some embodiments, may be included as part of a RAN paging procedure for the UE. In certain embodiments, if there is no network slicing configured by the service provider, then RAN-based Notification Area (RNA) may be sufficient to identify the area for paging. If network slice is configured by the service provider, then this information may be conveyed in the messages between network entities. For example, the network entity may transmit a setup message including the configured network slices inside of the entity to other network elements or entities. For specific messages related to individual UEs, such as RAN Paging, the network entity may identify the supported network slices for the UE.

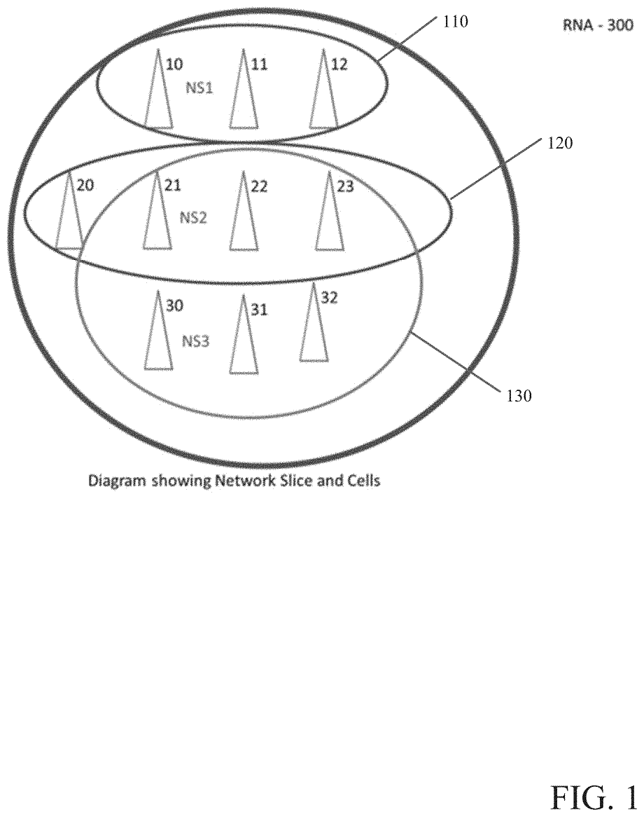

FIG. 1 illustrates an example of a system according to certain embodiments. In particular, FIG. 1 illustrates a radio access network having three network slices 110, 120, and 130. A network slice may be referred to as a logical network that provides specific network capabilities and network characteristics. As can be seen in FIG. 1, a RAN notification area 300 may include three different network entities being served by different cells 10, 11, 12, 20, 21, 22, 23, 30, 31, and 32. A network slice 110 (NS1) may be an area within the radio access network that encompasses or includes three different cells 10, 11, and 12 that belong to one or more network entities. The network entity, for example, may be a gNB, ng eNB, or NG-RAN. Network slice 120 (NS2), on the other hand, may be an area of the network that encompasses or includes four different cells 20, 21, 22, and 23. Network slice 130 (NS3) may be an area of the network that includes six different cells 21, 22, 23, 30, 31, and 32.

In certain embodiments, a UE may have a subscription to one or more network slices or network areas. A network area that includes cells supporting services to which a UE has a subscription may be referred to as a network slice area. A slice identification may be assigned to each of the network slices. The slice identification may be transmitted to a neighboring network entity to indicate the network slice. For example, the slice identification may be NS1, NS2, and NS3, which may be transmitted to a network entity to indicate the slice. The slice identification may be associated with one or more cell identifications. For example, NS1 may be associated with cell identifications 10, 11, and 12, NS2 may be associated with cell identifications 20, 21, 22, and 23, while NS3 may be associated with cell identifications 30, 31, 32, 21, 22, and 23.

In certain embodiments, an NG RAN may be associated with one or more serving cell. For example, NR1, NR2, and NR3 are different NG RANs. NR1 may be associated with cell identifications 10 and 20, NR2 may be associated with cell identifications 11, 21, 22, 31, and 30, while NR3 may be associated with cell identification 12, 23, and 32. The one or more serving cells in a given NG-RAN may be included in different network slices. For example, while NR1 is associated with serving cells having cell identifications 10 and 20, cell identification 10 may be associated with NS1, while cell identification 20 may be associated with NS2.

A UE, in some embodiments, may have a subscription to network slice identification NS3, as shown in FIG. 1. In other words, the UE may register with the 5G Network from NG-RAN NR3. The UE, in certain embodiments, may be moved to an inactive mode, referred to as RRC_INACTIVE state. In the inactive mode, the UE may move between any cells included in RNA 300, without performing RNA update procedures, meaning that the UE does not notify the network as it moves within RNA 300 in an inactive mode. When the core network, or any part of the network, receives or anticipates downlink data for the RRC_INACTIVE UE, a network entity located in NR3, for example, may page the UE in cells 12, 23, 32, located within NR3. In addition, the network entity located in NR3 may send a paging message to NR2 and NR1. The paging message, for example, may be transmitted via the Xn interface to a network entity located within the NR1 or NR2. Sending paging messages to NR1 and NR2, however, may be a waste of resources since the UE is configured with NS3, meaning that it may only be served by cells 30, 31, 32, 21, 22, and 23.

Certain embodiments, therefore, may consider the network slice configured for the RRC inactive UE before transmitting a paging message to one or more neighboring network entities or before deciding the cells to which an RRC inactive UE may be paged. In other words, certain embodiments may use the RAN-Based Notification Area and the configured network slice for the UE before transmitting the paging message when the UE is in RRC inactive mode. Doing so will lead to improved resource utilization, thereby improving the overall functioning of the network and the entities included within the network. In certain embodiments that account for the RNA and network slice, the network entity may need to page cells 30, 31, 32, 21, 22, and 23, as shown in FIG. 1. In other words, the network entity NR3 may page the UE in cells 23 and 32. On the other hand, the network entity would not page cell 12 because cell 12 is not part of the network slice supported by the UE. In some embodiments, the network entity NR3 may transmit a paging message only to NR2, since NR1 may not support network slice NS3. When NR2 receive the paging message, it may page the user equipment in cells 21, 22, 31, and 30, without paging cell 11, since cell 11 does not support NS3.

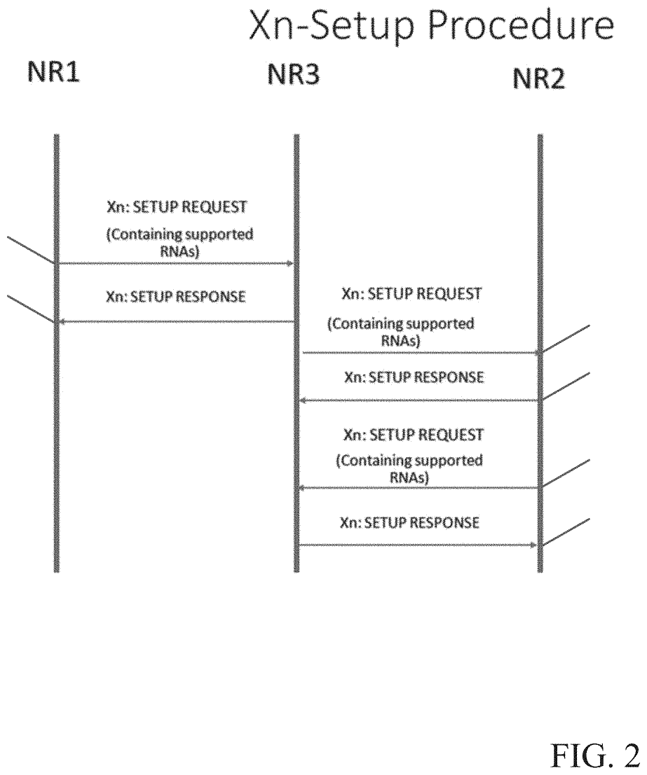

FIG. 2 illustrates an example of a signal flow diagram according to certain embodiments. In particular, FIG. 2 illustrates an Xn setup procedure in which the supported RAN-Based Notification Areas are conveyed to the neighboring entities. As shown in FIG. 2, the network may include three neighboring NG-RANs, NR1, NR3 and NR2. One or more of the network entities NR1, NR2, and/or NR3 may inform one or more neighboring network entities about the supported RNAs. In step 210, a network entity located in NR1 may send a setup request to NR3 including the configured RNAs in NR1.

In some embodiments, the network entity may receive the supported RNAs and transmit a paging message to one or more neighboring network entities based on the supported area. The RAN paging message, for example, may be transmitted via an Xn interface. When transmitting the paging message, the network entity may choose to transmit the paging message to those network entities configured with the same supported RNA applicable to the UE in an inactive mode. In step 220, the network entity located in NR3 may transmit a setup response to a neighboring network entity located in NR1.

In step 230, network entity NR3 may transmit a setup request message to network entity NR2 including the supported RAN_Based Notification Areas configured in NR3. In step 240, network entity NR3 may receive a setup response. In step 250, the network entity in NR3 may receive a setup request message from the network entity in NR2. The setup request message received in step 250 may include the supported RNAs. In response, the network entity in NR3 may transmit a setup response message to the network entity in NR2, as shown in step 260.

In certain embodiments, the network entity may transmit a paging message based on the supported area. The paging message, for example, may include configured network slices of the NG-RAN. The RAN paging message may be sent to only those NG RAN's which support UEs allowed or subscribed Single Network Slice Selection Assistance Information (S-NSSAI). The paging message may then be transmitted based on the supported network slice identification. The network slice identification, for example, may be NS1, NS2, and/or NS3. The supported network slice identifications may be used by the network to transmit the paging message to those cells that are configured for those specific network slices that are supported or allowed for by the UE.

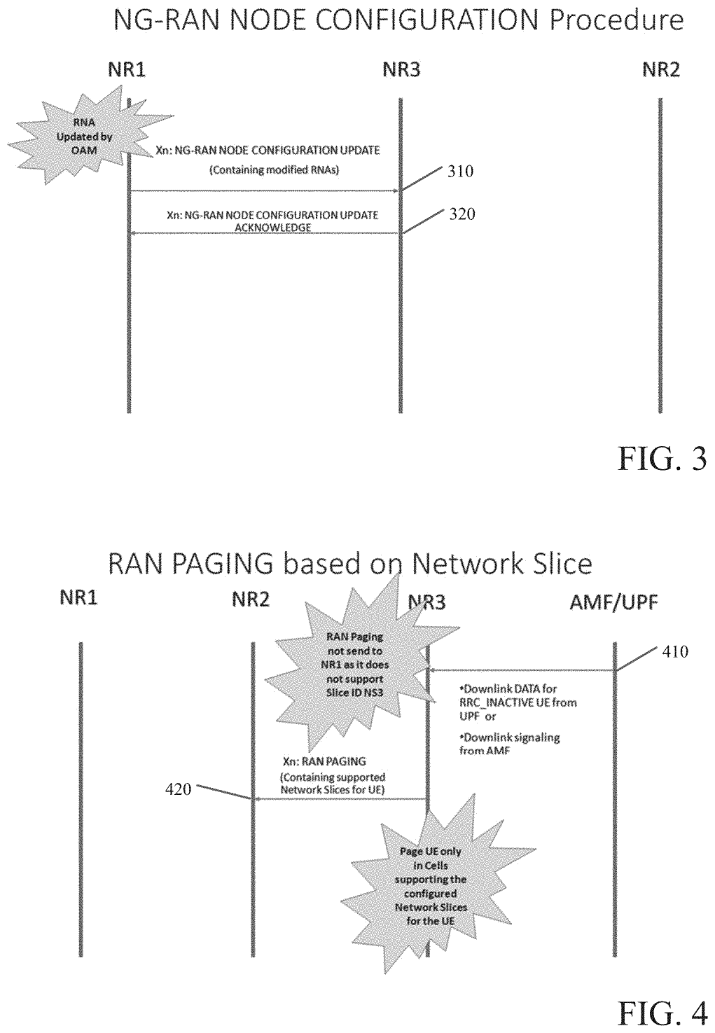

FIG. 3 illustrates a signal flow diagram according to certain embodiments. In particular, FIG. 3 illustrates a NG-RAN node configuration procedure. As can be seen in FIG. 3, the RNA may be configured in a network entity, and may be updated or modified. In certain embodiments, the supported area may be updated or modified by an Operation, Administration, and Maintenance (OAM) entity or any other core network entity. In step 310, the network entity located in NR1 may transmit an updated configuration that includes the modified or updated RNA to one or more neighbor network entities. The paging message may be transmitted based on the updated or modified configuration of the supported area. In step 320, the network entity may transmit an updated configuration acknowledgment message.

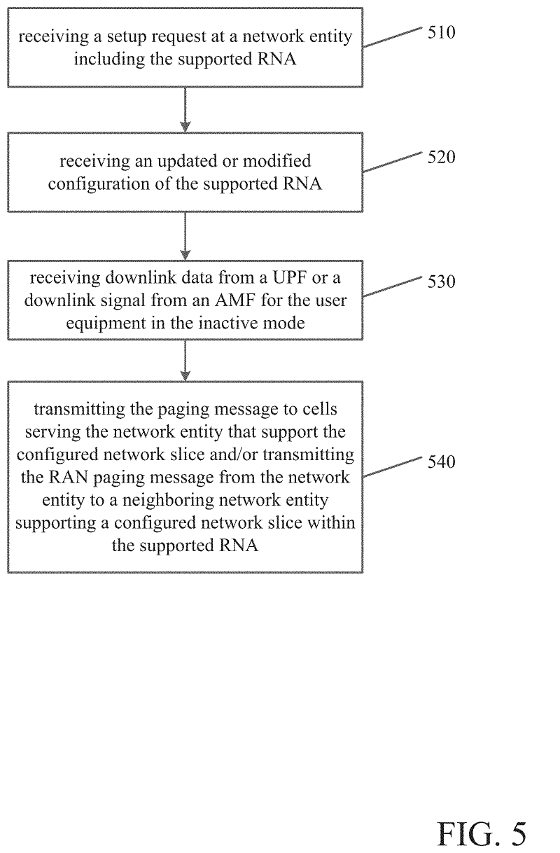

FIG. 4 illustrates a signal flow diagram according to certain embodiments. In particular, FIG. 4 illustrates a RAN paging based on the network slice or the supported network area. The network shown in FIG. 4 may include NR1, NR2, NR3, AMF, and/or UPF. In step 410, the network entity NR3 may receive downlink data from a UPF or a downlink signal from an AMF for the UE in the inactive mode. The downlink data, for example, may be transmitted to the network entity using an N2 interface located between the network entity and the AMF. The reception of the downlink data may trigger the transmitting of the RAN paging message by the network entity. The paging in FIG. 4 may not be transmitted to the network entity in NR1 because the UE in the inactive mode does not support slice identification NS3.

In step 420, the network entity located in NR3 may transmit a RAN paging message to the neighbor network entity located in NR2. The RAN paging message, in certain embodiments, may include the supported network area (RNA) and supported network slices for the UE. The network entity, in some embodiments, may page RRC_INACTIVE UE in cells that support the configured network slice and network area (RNA).

FIG. 5 illustrates an example of a method according to certain embodiments. In particular, FIG. 5 illustrates a method performed by a network entity. The network entity, for example, may be an NG-RAN node, a gNB, or a ng-eNB. The network entity, for example, may transmit or send at least one of a setup request including the supported RNA and/or an updated or modified configuration request to another neighboring network entity including the updated or modified RNA. The setup request, in certain embodiments, may include the supported radio access network based notification area. In step 510, the network entity may receive a setup request at a network entity. The setup request may include a supported radio access network based notification area for a UE movement in an RRC inactive mode. In certain embodiments, the setup request may be an Xn interface setup request.

In certain embodiments, the setup request may include a supported network slice identity and an indication of the supported RNA. The RAN paging message may be transmitted based on the supported network slice identity or the indication. In step 520, the network entity may receive an updated or modified configuration of the supported RNA. In step 530, the network entity may receive downlink data from a UPF or a downlink signal from an AMF for the UE in the RRC inactive mode. The reception of the downlink data may trigger the transmitting of the RAN paging message. In step 540, the network entity may transmit a RAN paging message to a neighbor network entity supporting a configured network slice within the supported RNA. In certain embodiments, the network entity may page for the RRC Inactive UE in cells included in RNA and serving the network entity that support the configured network slice for the UE. The RAN paging message may be transmitted based on the supported network slice identity or the indication. The RAN paging message may also be transmitted based on the updated or modified configuration of the supported RNA. In some embodiments, the RAN paging message may include the supported network slice identity and the indication of the supported RNA.

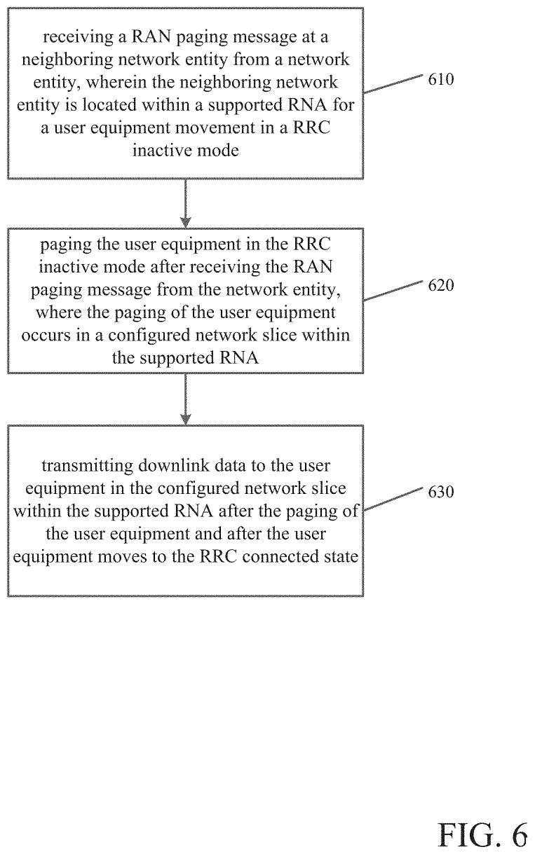

FIG. 6 illustrates an example of a method according to certain embodiments. In particular, FIG. 6 illustrates a method performed by a neighboring network entity. The neighboring network entity, for example, may be an NG-RAN node, a gNB, or a ng-eNB. The neighbor network entity illustrated in FIG. 6 may communicate with the network entity illustrated in FIG. 5. In step 610, the neighboring network entity may receive a RAN paging message from a network entity. The neighboring network entity may be located within a supported RNA for a user equipment movement in a RRC inactive mode. The RAN paging message may be received via an Xn interface. In certain embodiments, the RAN paging message may include a supported network slice identity and indication of the supported RNA.

In step 620, the neighboring network entity may page the user equipment in the RRC inactive mode after receiving the RAN paging message from the network entity. The paging of the user equipment may occur in a configured network slice within the supported radio access network based notification area. In other words, the user equipment may be paged only in cells that support the configured network slice for the user equipment and received in the RAN paging message from the neighboring entity. In step 630, the neighboring network entity may transmit downlink data to the user equipment after paging the user equipment in the configured network slice within the supported radio access network based notification area. The transmitting of the downlink data, for example, may occur after the paging of the UE and after the UE has moved from the RRC Inactive to the RRC connected state. In some embodiments, a configuration of the supported RNA may be updated or modified. The paging message may be transmitted based on the updated or modified configuration of the supported area.

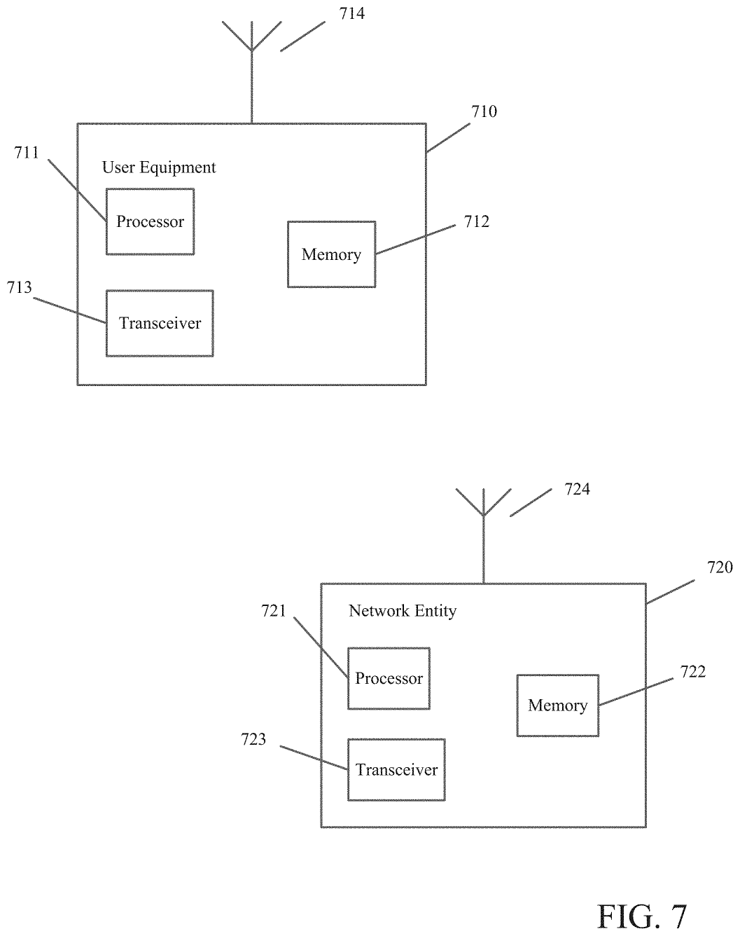

FIG. 7 illustrates a system according to certain embodiments. It should be understood that each signal or block in FIGS. 1-6 may be implemented by various means or their combinations, such as hardware, software, firmware, one or more processors and/or circuitry. In one embodiment, a system may include several devices, such as, for example, network entity 720 or user equipment (UE) 710. The system may include more than one UE 710 and more than one network entity 720. Network entity 720 may be a network node, a base station, an access point, an access node, a gNB, an ng eNB, a server, a host, or any other network entity that may communicate with the UE.

Each of these devices may include at least one processor or control unit or module, respectively indicated as 711 and 721. At least one memory may be provided in each device, and indicated as 712 and 722, respectively. The memory may include computer program instructions or computer code contained therein. One or more transceiver 713 and 723 may be provided, and each device may also include an antenna, respectively illustrated as 714 and 724. Although only one antenna each is shown, many antennas and multiple antenna elements may be provided to each of the devices. Other configurations of these devices, for example, may be provided. For example, network entity 720 and UE 710 may be additionally configured for wired communication, in addition to wireless communication, and in such a case antennas 714 and 724 may illustrate any form of communication hardware, without being limited to merely an antenna.

Transceivers 713 and 723 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network entity deliver local content. One or more functionalities may also be implemented as virtual application(s) in software that can run on a server.

A user device or UE 710 may be a mobile station (MS) such as a mobile phone or smart phone or multimedia device, an IoT cellular device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. In other embodiments, the user equipment may be replaced with a machine communication device that does not require any human interaction, such as a sensor, meter, or robot.

In some embodiments, an apparatus, such as a user equipment or a network entity, may include means for carrying out embodiments described above in relation to FIGS. 1-6. In certain embodiments, at least one memory including computer program code can be configured to, with the at least one processor, cause the apparatus at least to perform any of the processes described herein.

Processors 711 and 721 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 712 and 722 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network entity 720 or UE 710, to perform any of the processes described above (see, for example, FIGS. 1-6). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

In certain embodiments, an apparatus may include circuitry configured to perform any of the processes or functions illustrated in FIGS. 1-6. Circuitry, in one example, may be hardware-only circuit implementations, such as analog and/or digital circuitry. Circuitry, in another example, may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

The above embodiments may be directed to computer-related technology that provides significant improvements to the functioning of a network and/or to the functioning of the network entities within the network, or the user equipment communicating with the network. For example, the above embodiments may help to improve system or network performance, while allowing the RAN paging area for a UE in an inactive mode to be based on the supported network slices. Accounting for a supported area of a UE in an inactive mode may improve resource utilization with optimized signaling. The reduced use of resources may help to improve network performance, while allowing those resources to be used for the UE or other network entities.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one example embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the example embodiments of the invention as discussed above may be practiced with steps in a different order, and/or with hardware elements in configurations which are different than those which are disclosed. Therefore, although the examples of the invention have been described based upon these preferred embodiments, it would be apparent to those of skill in the art that certain modifications, variations, and alternative constructions would be apparent, while remaining within the spirit and scope of the invention. Although the above embodiments refer to 5G, NG, or NR technology, the above embodiments may also apply to any other present or future 3GPP technologies, such as Long Term Evolution (LTE), LTE-advanced, IoT technology, fourth generation (4G) technology, or any non-3GPP technology.

Partial Glossary

3GPP 3rd Generation Partnership Project

NG-RAN NG Radio Access Network

AMF Access and Mobility Management Function

UPF User Plane Function

Xn interface Interface between two NG-RAN

N2 interface Interface between an NG-RAN and AMF

RRC Radio resource control

RNA RAN-based Notification Area

We claim:

1. An apparatus comprising:
at least one processor; and
at least one memory and computer program code, wherein the at least one memory and the computer program code are configured, with the at least one processor, to cause the apparatus at least to:
receive a setup request, wherein the setup request comprises a supported radio access network based notification area for a user equipment movement in a radio resource control inactive mode; and
transmit a radio access network paging message to a neighboring network entity supporting a configured network slice within the supported radio access network based notification area.

2. The apparatus according to claim 1, wherein the at least one memory and the computer program code are configured, with the at least one processor, to cause the apparatus at least to:
transmit the paging message for the user equipment in the radio resource control inactive mode to cells included in the supported radio access network based notification area and serving the apparatus that support the configured network slice.

3. The apparatus according to claim 1, wherein the setup request is an Xn interface setup request.

4. The apparatus according to claim 1, wherein the setup request comprises a supported network slice identity and an indication of the supported radio access network based notification area, wherein the radio access network paging message is transmitted based on the supported network slice identity or the indication.

5. The apparatus according to claim 4, wherein the radio access network paging message comprises the supported network slice identity.

6. The apparatus according to claim 1, further comprising:
send at least one of a setup request including the supported radio access network based notification area or an updated or modified configuration request to another neighboring network entity including the updated or modified radio access network based notification area.

7. The apparatus according to claim 1, wherein the at least one memory and the computer program code are configured, with the at least one processor, to cause the apparatus at least to:
receive an updated or modified configuration of the supported radio access network based notification area, wherein the radio access network paging message is transmitted based on the updated or modified configuration of the supported radio access network based notification area.

8. The apparatus according to claim 1, wherein the at least one memory and the computer program code are configured, with the at least one processor, to cause the apparatus at least to:
receive downlink data from a user plane function or a downlink signal from an access and mobility management function for the user equipment in the radio resource control inactive mode, wherein the reception of the downlink data triggers the transmitting of the radio access network paging message.

9. A method comprising:
receiving a setup request at a network entity, wherein the setup request comprises a supported radio access network based notification area for a user equipment movement in a radio resource control inactive mode; and
transmitting a radio access network paging message from the network entity to a neighboring network entity supporting a configured network slice within the supported radio access network based notification area.

10. The method according to claim 9, further comprising:
transmitting the paging message for the user equipment in the radio resource control inactive mode to cells included in the supported radio access network based notification area and serving the network entity that support the configured network slice.

11. The method according to claim 9, wherein the setup request comprises a supported network slice identity and an indication of the supported radio access network based notification area, wherein the radio access network paging message is transmitted based on the supported network slice identity or the indication.

12. The method according to claim 11, wherein the radio access network paging message comprises the supported network slice identity.

13. The method according to claim 9, further comprising:
sending from the network entity at least one of a setup request including the supported radio access network based notification area or an updated or modified configuration request to another neighboring network entity including the updated or modified radio access network based notification area.

14. The method according to claim 9, further comprising:
receiving an updated or modified configuration of the supported radio access network based notification area, wherein the radio access network paging message is transmitted based on the updated or modified configuration of the supported radio access network based notification area.

15. The method according to claim 9, further comprising:
receiving downlink data from a user plane function or a downlink signal from an access and mobility management function for the user equipment in the radio resource control inactive mode, wherein the reception of the downlink data triggers the transmitting of the radio access network paging message.

16. An apparatus comprising:
at least one processor; and
at least one memory and computer program code, wherein the at least one memory and the computer program code are configured, with the at least one processor, to cause the apparatus at least to:
receive a radio access network paging message from a network entity, wherein the apparatus is located within a supported radio access network based notification area for a user equipment movement in a radio resource control inactive mode; and
page the user equipment in the radio resource control inactive mode after receiving the radio access network paging message from the network entity, wherein the paging of the user equipment occurs in a configured network slice within the supported radio access network based notification area.

17. The apparatus according to claim 16, wherein the radio access network paging message is received via an Xn interface.

18. The apparatus according to claim 16, wherein the radio access network paging message comprises a supported network slice identity and an indication of the supported radio access network based notification area.

19. The apparatus according to claim 16, wherein a configuration of the supported radio access network based notification area is updated or modified, wherein the radio access network paging message is transmitted based on the updated or modified configuration of the supported area.

20. The apparatus according to claim 16, wherein the at least one memory and the computer program code are configured, with the at least one processor, to cause the apparatus at least to:
transmit downlink data to the user equipment in the configured network slice within the supported radio access network based notification area after the paging of the user equipment and after the user equipment moves to the radio resource control connected state.
